(19) United States
(12) Patent Application Publication
(10) Pub. No.: US 2024/0430008 A1
(43) Pub. Date: Dec. 26, 2024

(54) CONTENTION-BASED ACCESS FOR OPTICAL WIRELESS COMMUNICATION SYSTEMS

(71) Applicant: SIGNIFY HOLDING B.V., EINDHOVEN (NL)

(72) Inventors: MATTHIAS WENDT, WÜRSELEN (DE); ANDRIES VAN WAGENINGEN, WIJLRE (NL); NANCY YUSHAN LEE, EINDHOVEN (NL); ROBERT JAMES DAVIES, EINDHOVEN (NL)

(21) Appl. No.: 18/708,240

(22) PCT Filed: Nov. 8, 2022
(86) PCT No.: PCT/EP2022/081074

§ 371 Date: May 8, 2024

(30) Foreign Application Priority Data
Nov. 11, 2021 (EP) 21207663.2

(51) Int. Cl. H04B 10/116; H04B 10/114; H04B 10/40

(52) U.S. Cl. CPC H04B 10/116; H04B 10/114; H04B 10/40

(57) ABSTRACT

This invention relates to an optical wireless communication (OWC) system that is configured to make use of observations of straylight reflections as generated by an OWC transmitter in order to support contention-based channel access including that of multiple basic or extended service sets (BSS, ESS) with overlapping coverage areas. It is proposed to have an additional optical signal or signal component generated in the OWC transmitter which allows for simple detection without having to do heavy digital demodulation processing. A learning phase may allow to adjust for environmental conditions like reflectivity or transmitter characteristics.

### FIELD OF THE INVENTION

The invention relates to the field of signal transmission in optical communication networks, such as—but not limited to—LiFi networks, for use in various different applications for home, office, retail, hospitality and industry.

### BACKGROUND OF THE INVENTION

Wireless communication via light is rapidly gaining interest. Optical wireless communication (OWC) systems, such as LiFi networks (named like WiFi networks), enable mobile user devices (called end device (ED) units in the following) like laptops, tablets, smartphones or the like to connect wirelessly to the internet via fixed devices (called access points (AP)). WiFi achieves this using radio frequencies, but LiFi achieves this using the light spectrum which can enable unprecedented data transfer speed and bandwidth. Furthermore, it can be used in areas susceptible to electromagnetic interference. An important point to consider is that wireless data is required for more than just our traditional connected devices. Today, televisions, speakers, headphones, printer's, virtual reality (VR) goggles and even refrigerators use wireless data to connect and perform essential communications. Radio frequency (RF) technology like WiFi is running out of spectrum to support this digital revolution and LiFi can help power the next generation of immersive connectivity.

OWC refers to techniques by which information is communicated in the form of a signal embedded in light (including for example visible light or invisible light, such as for example infrared (IR) light or ultraviolet (UV) light) emitted by a light source. Depending for example on the particular wavelengths used, such techniques may also be referred to as coded light, Light Fidelity (LiFi), visible light communication (VLC) or free-space optical communication (FSO). In this context, visible light may be light that has wavelengths in the range 380 nm to 740 nm and infrared (IR) light may be light that has wavelengths in the range 740 nm to 1.5 mm. There may be some overlap between these ranges.

Based on modulations, information in the coded light can be detected using any suitable light sensor. This can be a dedicated photocell (point detector), an array of photocells possibly with a lens, reflector, phosphorous diffuser etc., or a camera comprising an array of photocells (pixels) and a lens for forming an image on the array. E.g., the light sensor may be a dedicated photocell included in a dongle which plugs into the end point, or the sensor may be a general purpose (visible or invisible light) camera of the end point or an infrared detector initially designed for instance for 3D face recognition. Either way this may enable an application running on the end point to receive data via the light.

OWC nodes like access points (APs) or end points/devices (ED units) may not be able to communicate via OWC with neighbor APs or neighbor ED units, respectively, as their optical frontends are arranged parallel to each other with similar viewing direction and thus cannot receive each other's transmissions. Such a situation is called “hidden node problem”, since an OWC node (e.g., ED unit) can communicate with an OWC AP but cannot directly communicate with other nodes that are communicating with that AP, or vice versa. This leads to difficulties in medium access control sublayer since multiple ED units can send data packets to the AP simultaneously, or vice versa, which creates interference resulting in no packet getting through.

Furthermore, OWC nodes often transmit using intensity modulation on the same broad wavelength light channel and receive using a fixed wide spectrum light detector (e.g., 800 nm-1000 nm), unlike in e.g. WiFi systems where neighboring APs or basic service sets (BSSs) or extended service sets (ESSs) can avoid interfering with one another by using non-overlapping channel frequencies and selectively receiving only a desired channel.

Although some loss of packets is acceptable in wireless networking and higher protocol layers may arrange for resending them, if one of the nodes is transferring a lot of large packets over a long period, another node may get very little throughput.

### SUMMARY OF THE INVENTION

It is an object of the present invention to mitigate the hidden node problem in OWC systems.

This object is achieved by an apparatus as claimed in claim 1, by an optical wireless communication device as claimed in claim 8, by a method as claimed in claim 14, and by a computer program product as claimed in claim 15.

According to a first aspect, an apparatus is provided for detecting a busy channel in an optical wireless communication, the apparatus comprising:
a detector for detecting a straylight signal originating from an environment of a target area; and
a discriminator for monitoring the detected straylight signal to discriminate a dedicated signal component that indicates channel occupancy by a neighbor transmission directed towards the target area.

According to a second aspect, a method of detecting a busy channel in an optical wireless communication is provided, the method comprising:
generating a dedicated signal component to indicate an occupied channel;
transmitting the dedicated signal component together with an optical communication signal towards a target area;
detecting a straylight signal originating from an environment of the target area; and
monitoring the detected straylight signal to discriminate the dedicated signal component as an indicator for channel occupancy by a neighbor transmission.

Accordingly, observations of the straylight reflections as generated by an OWC transmitter are observed in order to detect an occupied channel and support coordinated (e.g., contention-based) channel access including that of multiple basic service sets (BSS) with overlapping coverage areas. The additional optical signal component generated in the OWC transmitter allows for simple detection without complex digital demodulation processing and without any involvement of the ED units.

The proposed solution further allows for an add-on implementation of the proposed straylight-based busy channel detection. Thereby, conventional OWC devices can be enhanced to make use of straylight-based channel monitoring.

According to a third aspect, an optical wireless communication device (e.g., access point or end point or end device) is provided which comprises an apparatus according to the first aspect and a transceiver for optical wireless communication.

According to a fourth aspect, a computer program product is provided, which comprises code means for producing the steps of the above method of the second aspect when run on a controller device.

According to a first option of any of the first to fourth aspects, the dedicated signal component may comprise at least one of an additional out-of-band modulation, a code or address information allowing transmitter identification, a pilot carrier, a transmitter-specific spectral signature, a subset of subcarriers or a single subcarrier of the neighbor transmission. Thus, various alternatives or combination can be provided to ensure simple detection of channel occupancy without complex digital demodulation processing even in cases of low reception quality of the straylight signal.

According to a second option of any of the first to fourth aspects, which can be combined with the first option, the dedicated signal component may be an intermittent signal component. This provides the advantage that power consumption can be minimized as long as initial idle periods for OWC channel access do not expire in the transmission pauses, so that the OWC channel cannot be used by neighboring OWC devices.

According to a third option of any of the first to fourth aspects, which can be combined with the first or second option, the detector may be a separate detector with at least one of higher amplification or sensitivity, increased detection surface, and smaller signal bandwidth, as compared to a main detector used for the optical wireless communication. These measures ensures that weak straylight signals can be received with a higher reception quality sufficient to allow discrimination of the added dedicated signal component.

According to a fourth option of any of the first to fourth aspects, which can be combined with any one of the first to third options, the detector may be arranged to surround the main detector at least partially. Thereby, the proposed straylight detection can be achieved with a wider field of view than the normal OWC communication to provide better straylight coverage and/or better detection quality.

According to a fifth option of any of the first to fourth aspects, which can be combined with any one of the first to fourth options, straylight receiving optics allocated to the detector may be configured to provide a wider field of view than the field of view of main receiving optics used for optical wireless communication. Thereby, a further option for straylight detection with a wider field of view than the normal OWC communication can be provided, so as to improve straylight coverage and/or detection quality.

According to a sixth option of any of the first to fourth aspects, which can be combined with any one of the first to fifth options, the straylight receiving optics may be controllable to provide a variable field of view. This measure provides the advantage that the distance to neighboring OWC devices can be estimated based on the level of interference for different field-of-view settings.

According to a seventh option of any of the first to fourth aspects, which can be combined with any one of the first to sixth options, the OWC device may be configured to make use of a discriminated dedicated signal component to support coordinated channel access of multiple basic service sets with overlapping coverage areas. Thereby, interfering channel access by neighboring OWC devices can be prevented, e.g., by a contention-based channel access scheme.

According to an eighth option of any of the first to fourth aspects, which can be combined with any one of the first to seventh options, the OWC device may further comprise a busy signal generator configured to generate the dedicated signal component and to add the dedicated signal component to a drive signal for a main transmitter or a separate transmitter of the transceiver. Thus, a separate dedicated signal component can be generated and added to the main OWC transmission, so that discrimination of a valid straylight signal caused by channel occupancy can be facilitated.

According to a ninth option of any of the first to fourth aspects, which can be combined with any one of the first to eighth options, the busy signal generator may be coupled to a transmission optics that provides a wider field of view than the transmission optics used for the main transmitter. Thereby, coverage of the dedicated signal component in an environment of the target area can be increased to improve the amount of straylight caused by the environment.

According to a tenth option of any of the first to fourth aspects, which can be combined with any one of the first to ninth options, the OWC device may be configured to exchange with at least one other optical wireless communication device via a backbone network, information about a channel usage by the transceiver for cross correlation with detected straylight signals to identify an optical wireless communication device located in the neighborhood or related interferences. This measure allows for calibration of a neighborhood situation (e.g., neighbor table) useful for evaluating straylight detection.

According to an eleventh option of any of the first to fourth aspects, which can be combined with any one of the first to tenth options, the OWC device may be configured to provide a learning phase to learn at least one of environmental conditions and/or transmitter radiation behaviors and their related effects on straylight detection, effects of a ratio between wider and narrower fields of view of the detector on the straylight detection, non-interfering transmitters, and an intensity required for the dedicated signal component to be recognized by a neighbor optical wireless communication device. Thereby, environmental effects on busy channel detection (e.g., amount and level of reflections, neighboring OWC nodes, etc.) can be learned, e.g., in an initial test phase or during normal operation learning phases which May be triggered e.g. when massive interferences are detected.

It is noted that the above apparatuses may be implemented based on discrete hardware circuitries with discrete hardware components, integrated chips, or arrangements of chip modules, or based on signal processing devices or chips controlled by software routines or programs stored in memories, written on a computer readable media, or downloaded from a network, such as the Internet.

It shall be understood that the apparatus of claim 1, the optical wireless communication device of claim 8, the method of claim 14, and the computer program product of claim 15 may have similar and/or identical preferred embodiments, in particular, as defined in the dependent claims.

It shall be understood that a preferred embodiment of the invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIG. 1 shows schematically an application scenario of an OWC usage in a meeting room;

FIGS. 2A and 2B show two exemplary interference scenarios of OWC systems;

FIG. 3 shows schematically a timing diagram of a distributed coordination function;

FIG. 4 shows schematically a first exemplary illustration of a straylight-based detection of a busy channel according to an embodiment;

FIG. 5 shows schematically a block diagram of a straylight-based busy channel detector according to an embodiment;

FIG. 6 shows schematically a second exemplary illustration of a straylight-based detection of a busy channel with receivers having different fields of view according to an embodiment; and

FIG. 7 shows a flow diagram of straylight-based busy channel detection procedure according to an embodiment.

### DETAILED DESCRIPTION OF EMBODIMENTS

Various embodiments of the present invention are now described based on an optical wireless illumination and communication (LiFi) system with contention-based access with busy channel detection and/or neighbor coordination and mapping by means of straylight caused by any kinds of reflection, refraction, scattering, backscattering, diffraction or the like. For example, neighboring access devices could coordinate their transmissions to not overlap in time and/or wavelength and/or the location of other OWC nodes could be detected to generate a map of interfering access devices. Such mapping is relevant for coordinating scheduling between access devices and may be combined with contention-based access within an access device and it's served OWC nodes. Although the present invention is particularly advantageous within the context of an illumination system, the invention is not limited thereto and may also be used within an optical wireless communication system that is not integrated within an illumination system. Throughout the following, a light source may be understood as a radiation source that generates visible or non-visible light (i.e., including infrared (IR) or ultraviolet (UV)) light sources) for communication purposes. The light source may be included in a luminaire, such as a recessed or surface-mounted incandescent, fluorescent or other electric-discharge luminaires. The concepts can also be used in peer-to-peer communication for example between smartphones or Internet of Things (IoT) devices.

It is further noted that when using optical wireless communication based on invisible parts of the light spectrum, such as infrared and/or or ultraviolet, the system can be fully decoupled from any illumination systems. In such scenarios the optical wireless communications systems may function to primarily provide communication and a separate transceiver node may be used in the optical wireless communication system. Alternatively, such optical wireless communication systems may be complementary to a further function and thus be integrated in other application devices that benefit from such communication function; such as personal computers, personal digital assistants, tablet computers, mobile phones, televisions, etc.

Conventional light source luminaires are rapidly being replaced by light emitting diode (LED) based lighting solutions. In LiFi systems, more advanced LED-based luminaires are enabled to act as LiFi communications hub to add LiFi connectivity to lighting infrastructure. The underlying idea is that an illumination infrastructure is positioned in such a manner that it provides a line of sight from the luminaire to locations where people tend to reside. As a result, the illumination infrastructure is also well positioned to provide optical wireless communication that likewise requires line of sight.

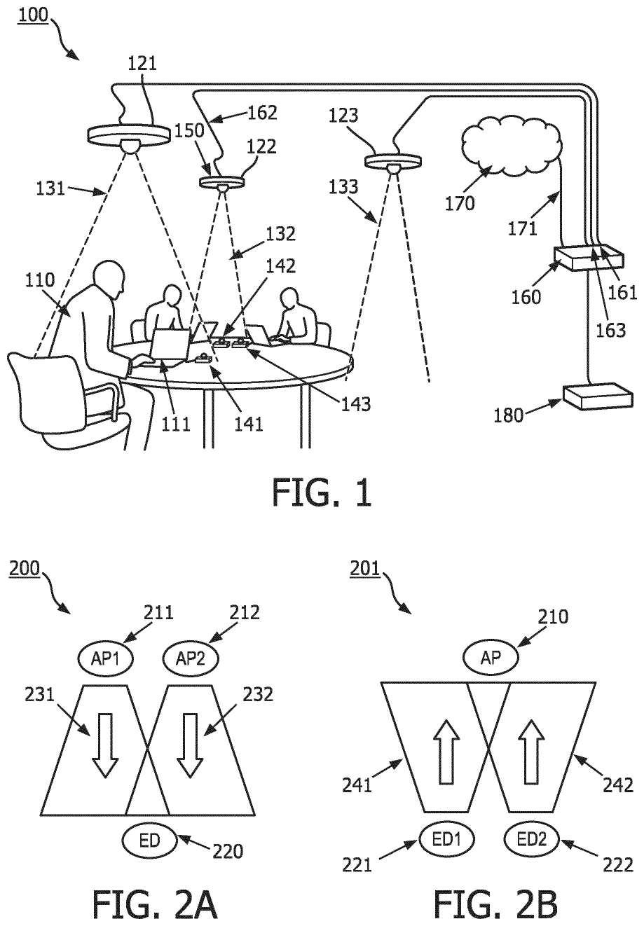

FIG. 1 shows schematically an application scenario of an OWC usage in a LiFi system provided in a meeting room 100 with multiple ceiling-mounted access points (APs) 121-123.

It is noted that-throughout the present disclosure-only those structural elements and functions are shown, which are useful to understand the embodiments. Other structural elements and functions are omitted for brevity reasons.

In the depicted meeting room 100 communication light beams 131, 132, 133 are projected down by the APs 121, 122, 123 and table end device (ED) units (i.e., EPs) 141, 142, 143 are placed near laptop computers 111 of occupants 110 within a respective one of the light beams 131 to 133. The ED units 141 to 143 may be connected to respective laptop computers 111 via connection interface (e.g., Universal Serial Bus (USB) or the like).

Using 802.11 terminology, an AP and ED units it serves are called a Basic Service Set (BSS), so that FIG. 1 depicts multiple BSS's that may have overlapping coverage areas. Furthermore, an Extended Service Set (ESS) is set of one or more interconnected BSSs that appears as a single BSS to the logical link control (LLC) layer at any OWC node associated with one of those BSSs. More specifically, an ESS is a union of infrastructure BSSs with the same service set identifier (SSID). Furthermore, a switching means (e.g., LiFi switch) 160 is connected via data cabling 161, 162, 163 (backbone network) to the OWC APs 121 to 123 and is configured to route data traffic e.g. from user devices (i.e., laptop computers 111) via a network connection line 171 towards the internet 170 or any cloud-based services.

An OWC controller entity 180 may also be connected to the network to allow coordination of light communication e.g. by reserving certain time slots for the APs 121 to 123 to transmit. Such a coordinating function may also be integrated with the switching means 160.

The ceiling mounted APs 121 to 123 may be integrated with luminaires 150 for general lighting, which provide a good placement for an AP function, as luminaires like the luminaire 150 are typically placed to illuminate a space most homogeneously and completely. Generally, the light beams 131 to 133 may have overlapping regions where receivers of the ED units 141 to 143 may experience interferences from multiple concurrently sending ones of the APs 121 to 123. Similarly, transmitters of the ED units 141 to 143 may produce overlapping light beams at the location of one of the APs 121 to 123 and resulting interferences may reduce communication quality.

As explained initially, OWC nodes like the APs 121 to 123 or the ED units 141 to 143 are not able to communicate via OWC with their neighbor nodes, as their optical frontends are arranged parallel to each other with similar viewing direction and therefore cannot receive or detect each other's transmissions.

Furthermore, OWC nodes often transmit using intensity modulation (such as on-off keying (OOK) or pulse amplitude modulation (PAM)) on the same broad light wavelength channel and receive using a fixed wide spectrum light detector (e.g., 800 nm-1000 nm), so that neighboring BSSs cannot avoid interfering with one another by using non-overlapping channel frequencies and selectively receiving only a desired channel.

FIGS. 2A and 2B show two exemplary interference scenarios of OWC systems. On the left in scenario 200 of FIG. 2A, two APs (AP1, AP2) 211 and 212 emit their light beams (OWC transmissions) 231, 232 substantially at the same time, but cannot observe or detect that the two light beams 231, 232 are potentially interfering with each other. A receiving ED unit 220 is accidentally placed in a position where it receives the two light beams 231 and 232. At the receiver, the respective signals of the two overlapping light beams 231, 232 are jointly received and may cancel or at least interfere with each other, which results in a reduced reception signal quality at the ED unit 220.

In the second scenario 201 of FIG. 2B on the right-hand side, two ED units (ED1, ED2) 221 and 222 may emit their respective light beams 241, 242 substantially at the same time, but also cannot observe or detect that the two light beams 241, 242 are potentially interfering with each other. An AP 210 is at a location where it receives the two independent OWC transmissions of the light beams 241 and 242. At the receiver of the AP 210, the respective signals of the two overlapping light beams 241, 242 are jointly received and may cancel or at least interfere with each other, which results in a reduced reception signal quality at the AP 210.

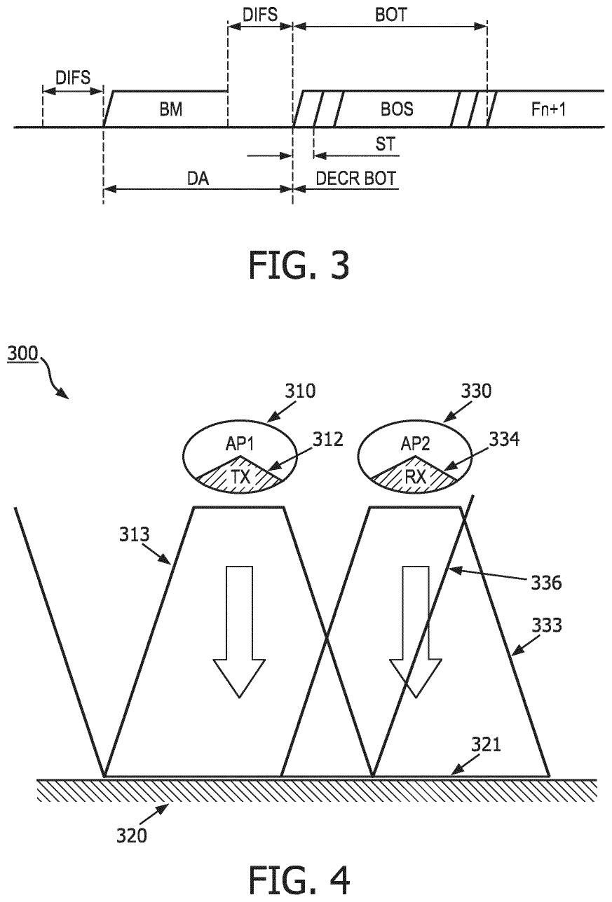

It is therefore proposed to observe straylight reflected, diffracted, scattered and/or refracted at surfaces or objects which are illuminated by the light beams to provide an opportunity to monitor whether a channel is busy (occupied) by OWC transmissions of a neighboring transmitter. Thus, straylight is sensed before an OWC channel is accessed. FIG. 3 shows schematically an exemplary timing diagram of a straylight-based access procedure by means of a distributed coordination function (DCF) that is based on the standard IEEE 802.11-2020 as one of several possible access procedures for wireless local area networks (WLANs).

When an OWC node determines that the medium is idle and remains idle for a predetermined period (e.g., a DCF interframe space (DIFS) and other conditions are met (e.g., its backoff counter which counts the backoff time (BOT) is zero), it is allowed to transmit. Otherwise, a random backoff procedure may be initiated.

More specifically, before the OWC node initiates an OWC transmission (e.g., data frame(s)), it senses the OWC channel for straylight in order to determine whether another OWC node is currently transmitting. When no valid straylight has been detected for an idle period equal to the DIFS period, the OWC node generates an initial BOT value which indicates an additional time period that the OWC node has to wait before actually starting the transmission (deferred access (DA)). This random backoff process serves to prevent collisions.

The BOT is made up of slot time (ST) units of backoff slots (BOS) and a backoff timer is decremented with each slot as long as the OWC channel is determined to be idle.

In FIG. 3, valid straylight of a parallel OWC transmission (i.e., busy medium (BM)) is detected after the initial DIFS period and the backoff timer is stopped. It starts to decrease (DECR BOT) when the OWC channel is sensed idle again for a further DIFS period. When the backoff timer reaches zero and the OWC channel is still idle, the next data frame (Fn+1) is finally transmitted.

As the OWC channel cannot directly be monitored for being idle, it is proposed to make use of observations of diffuse light reflections (straylight) as generated by the light beam of the transmitter of an OWC node in order to support coordinated (e.g., contention-based) channel access of multiple basic service sets (BSS) with overlapping coverage areas.

Depending on the reflecting surface and the distance to the transmitter, observable straylight (e.g., diffuse reflection and/or scattering and/or refraction and/or diffraction etc.) may be a weak signal. It may even be too weak for a normal reception and demodulation at the receiver of the OWC node. Therefore, instead of “reading” (i.e., demodulating and/or decoding) received straylight signals caused by communication data, it is proposed to only detect the presence of a neighbor OWC transmission signal. However, in many OWC systems, a non-transmitting transmitter of an OWC node may still emit an unmodulated direct current (DC) light beam, the straylight of which might erroneously be detected as an indication that the transmitter is sending. In general, light used for illumination, including daylight, also will be present. Because such light is substantially DC in nature, a discrimination option is required.

According to various embodiments, straylight caused by a neighbor OWC transmission signal is discriminated from straylight caused by a mere DC light signal, e.g., based on a detection of an (added) dedicated signal component. Thereby, little modification is required and conventional modems of OWC nodes can still be used for channel monitoring. Optionally, a learning phase may be provided to allow adjustment for environmental conditions like reflectivity or transmitter behaviors like emitting a constant bias radiation or the like.

In an embodiment, the transmitter of an OWC node may utilize an additional out-of-band modulation (e.g., a low-frequency modulation (e.g., 10-100 kHz) for signaling a busy state, which can be received by the low-bandwidth busy detector of a neighbor OWC node and which supports distinguishing from any other straylight sources in the surrounding space. In an example, a modulation signal which allows for simple detection without having to do heavy digital demodulation processing may be used. This modulation signal may be emitted by the main transmitter or, if present, the busy signal transmitter of the previous embodiment or both. In a specific example of 802.11 packets, it needs to be considered that the duration of such packets is of the order of 40-1000 us and DIFS is around 34 μs. This means that straylight detection should be achievable within a few microseconds. In this case a modulation in the range of 100-1000 KHz could be applied. In an example, the OWC node may comprise an additional ‘occupied’ or ‘busy’ signal transmitter that may have a wider FOV than the main transmitter used for OWC transmissions. The busy signal transmitter may emit only a utility signal to indicate that the main transmitter is sending a signal, but no other information.

In embodiments, straylight detection and neighbor identification can be initiated during idle times of OWC nodes. If an interferer can be identified, then mitigation procedures can be used to reduce potential interferences. For example, neighboring APs could coordinate their transmissions to not overlap in time and/or wavelength. Or, a central OWC controller entity, optionally collocated with one of the APs, could be responsible for such coordination. Consequently, reflected straylight may be utilized to detect “hidden” OWC nodes. This may be advantageous in OWC with or without mobile devices. In the latter case, mobile devices may be intermittently static and may then learn about interference conditions. In the very moment interference is detected again, device position(s) may have changed and a new learning phase may be triggered.

In some embodiments, a difference in field of view (FOV) between receiver and transmitter optics can be used for detecting interfering OWC nodes. Moreover, the FOV of the receiver may be variable, so that the receiver may, depending on its FOV setting, estimate the distance of neighbor nodes based on a measured level of interference. A similar information can be obtained in other embodiments where the receiver is segmented with segments in different elevation angles. Such a segmentation can also support detection of the location of other OWC nodes.

FIG. 4 shows schematically a first exemplary illustration of a scenario 300 of a straylight-based detection of a busy channel according to an embodiment.

It is noted that the proposed solution can be used for busy channel detection to support a contention-based distribution coordination function and/or for neighbor mapping to support scheduled coordination (by a scheduling function distributed between APs or centralized in an OWC controller). The scenario 300 illustrates how straylight is generated and how a neighbor AP (AP2) 330 is able to use it for neighbor or busy channel detection. A first AP (AP1) 310 has an active transmitter (TX) with a first field of view (FOV) 312 which generates a primary OWC beam 313. The OWC beam 313 gets reflected e.g. at a surface 321 of an office table 320 (or any surface which happens to be illuminated by the OWC beam 313).

In most cases, at least some of the incident light gets reflected by the surface 321. In the example of FIG. 4, a shiny surface 321 is provided, which mirrors the OWC beam 313 and thereby generates a first order (direct) straylight 336. It should be noted that most surfaces are not really reflecting the incoming light but generate a diffuse straylight beam which covers a bigger reflection angle than the incident angle. It should further be noted that IR light as frequently used in OWC systems is reflected by most surfaces with a relatively high ratio so that a substantial amount of straylight will shine upwards against the ceiling again where the transmitting AP 310 and the neighbor AP 330 are mounted. Moreover, it should also be noted that UV light is more susceptible to optical scattering, so that neighboring transmitters could be detected via this mechanism rather than reflections. This can be relevant in longer range outdoor situations (e.g., atmospheric scattering) or even underwater situations.

The neighbor AP 330 is configured to transmit an overlapping OWC beam 333 and to monitor with a receiver (RX) with a FOV 334 straylight that is generated by the neighboring transmitter of the first AP 310 in order to observe a channel busy state and thus overcome the initially explained hidden node problem of OWC systems. As already mentioned above, the straylight is substantially weaker than direct OWC beam light. Even if the reflectance of the surface 321 is very high (e.g., mirroring as depicted in FIG. 4), the straylight will be weaker compared to a receiving OWC node on the table 320, simply because of beam widening and doubled travelling distance.

In real world systems, straylight intensity may be much less, as typical surfaces generate a diffuse reflection which widens the reflected beam and hence reduces the detectable light. A suitable busy signal and busy detection method must therefore be applied. In this embodiment, it is proposed to use a different detector (straylight detector) with higher system sensitivity and possibly increased field of view for straylight detection. To obtain the necessary sensitivity, the straylight detector may be configured to operate in a narrow-band mode (e.g., low pass filter or band pass filter characteristic), since the content of the transmitted information does not need to be recovered and it is sufficient to detect the presence of a straylight transmission. In addition, due to diffuse surface reflections multipath straylight reflections will further reduce the transmittable bandwidth. In case a filter is used, the filter should be configured to at least exclude a DC component of the straylight and filter a busy indicator (i.e., the dedicated signal component). So, in essence any detected modulated straylight intensity may be indicative of a busy channel and may lead to a resetting of the DIFS time delay (deferred channel access) without trying to identify the transmitter.

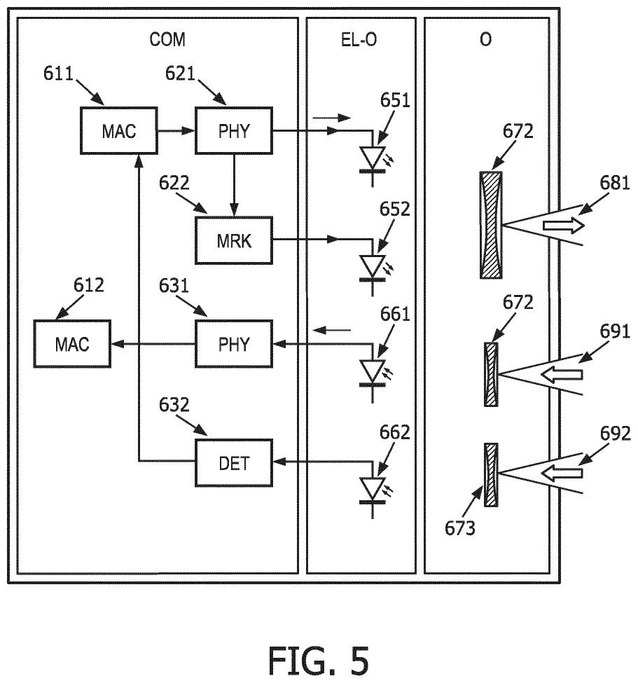

FIG. 5 shows schematically related functional blocks of a block diagram of a straylight-based busy channel detector according to an embodiment.

The functional blocks of the busy channel detector are divided into a communication stage (COM), an electro-optical stage (EL-O), and an optic stage (O). Related standards (such as the IEEE 802.15.7 standard) define both the physical protocol (PHY) and media access control protocol (MAC) layers for short-range OWC. The MAC layer is responsible for channel access coordination of user nodes (ED units) in the OWC network. Processes in the MAC layer are based on optical clocks, while the relation between optical clocks and data/control bits of OWC transmissions depends on the configuration of the PHY layer (e.g., modulation and encoding).

In FIG. 5, a MAC functionality is shown as a receiver MAC block 612 and a transmitter MAC block 611, which may be interwoven with each other and can be seen as a single unit. A transmitter function of the PHY layer 621 is adapted to generate a modulated signal that drives a main transmitter LED 651 (or other main radiation source) of the electro-optical stage. Transmitter optics 672 are configured to project the emitted light beam in a defined direction with a predetermined field of view (FOV) 681.

Additionally, a separate mark transmitter LED (or other mark radiation source) 652 is depicted for adding to the emitted communication light an additional dedicated signal component (e.g., marking light). The mark transmitter LED 652 is modulated by a marking modulation signal generated by a mark generator (MRK) 622. The marking modulation signal is used as a busy signal (i.e., dedicated signal component) to indicate a busy state of the OWC transmitter.

In another embodiment without separate mark transmitter LED 652, the mark generator 622 may be configured to add the marking modulation signal to the LED drive current for the main transmitter LED 651.

The mark generator 622 may receive a trigger input from the transmitter function 621 so that it only generates the busy signal (i.e., dedicated signal component) when the OWC transmitter is occupying the OWC channel.

In a further embodiment with the separate mark transmitter LED 652, an additional transmitter optics (not shown) with wider FOV may be provided for the separate mark transmitter LED 652, so that the marking modulation signal can be emitted as a separate transmission signal via a dedicated transmitter optics to achieve a wider coverage area for busy channel detection.

On the receiver side, a receiver optics 672 collects photons of a light signal coming from a communication partner from a defined FOV 691 which are converted into an electrical signal in a photodetector 661 of the electro-optical stage.

A receiver function 631 of the physical protocol layer (PHY) demodulates the data and provides it to the receiver MAC block 612 of the receiver side.

According to an embodiment, the straylight detecting process may be based on an additional FOV 692 for busy detection (i.e., straylight detection) as defined by an additional detector optics 673 and an additional photodetector 662.

As discussed above, the additional photodetector 662 may have a higher sensitivity at a more limited signal bandwidth. The electrical signal generated by the additional photodetector 662 may be processed in a detector unit (DET) 632 which may be e.g. a simple bandpass filter used to monitor the output of the additional photodetector 662 to identify a valid busy signal (i.e., dedicated signal component, such as the marking modulation) by discriminating it from a DC signal. The detection information is then fed to the transmitter MAC block 611 of the transmission side in order to signal a busy channel condition leading to a delay for any waiting transmissions (deferred access).

The additional optics 673 for collecting the straylight may be separate from the optics 672 for collecting the communication beam from the respective FOV 691. The additional FOV 692 may however be similar to the FOV 691 of the communication signal and the FOV 681 of the transmission beam to avoid that straylight originating from outside the coverage area of the OWC transceiver triggers a busy condition.

In another embodiment, a difference in FOV between the communication transceiver and the straylight detector is introduced. This may be achieved by using optics with different FOV or by the design of the electro-optical stage, e.g., the additional detection photodiode 662 may be arranged in a circle around the communication photodiode 661. In this way, the busy straylight detection will have a wider FOV than the communication path.

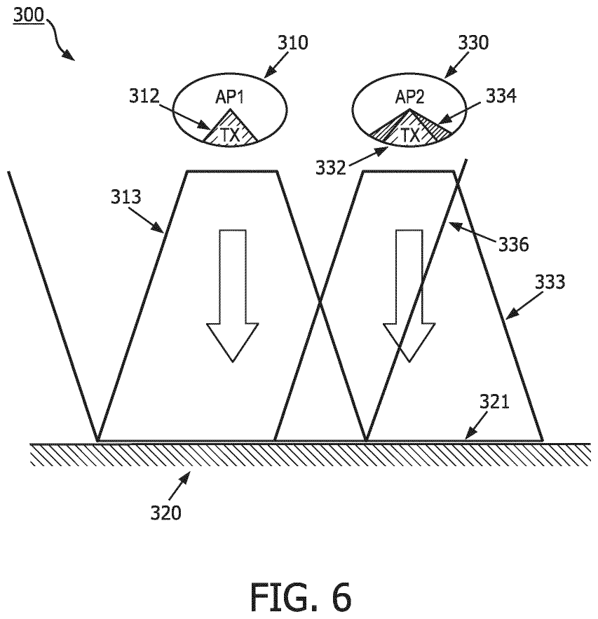

FIG. 6 shows schematically a second exemplary illustration of a scenario 300 of a straylight-based detection of a busy channel with receivers having different FOVs 332, 334 according to the other embodiment. Components of the illustration of FIG. 6, which correspond to those of FIG. 5 due to their same reference numbers, have the same structure and function and are therefore not necessarily described again.

As can be gathered from FIG. 6, the FOV 334 of the busy detector of the neighboring second AP (AP2) 330 is larger/wider than the FOV 332 of its transceiver (TRX) used for communication. This allows for detection of reflected straylight from a wide range of angles to ensure that all generated straylight can be used for busy detection. This is advantageous in environments which do not provide a uniformly flat reflective surface 321 perpendicular to the transceivers of the two neighboring APs 310 and 330.

A segmented transmitter (e.g., with a plurality of optically projecting segments) relatively far away from the receiver may still generate diffuse light reflections, e.g., due to reflecting walls. However, the wider FOV 334 of the busy detector means that a third AP (not shown) relatively far away may cause a busy channel detection at the neighbor AP 330 despite the second AP 330 and the third AP having no overlapping beam projection at the table 320, whereby the third AP cannot cause interference for an end device served by the second AP 330.

In a further embodiment, the busy detector 334 may be segmented by providing e.g. two optical detection segments, one with a narrower FOV and the other with a wider FOV. This may help to distinguish different straylight sources and the above problem of non-interfering transmission sources may be overcome.

Moreover, different ceiling heights and surface materials may influence the beam width of reflected straylight. During setup of the OWC system, a learning phase may be used to learn effects of the ratio between the wide and the narrow detectors on real busy detection scenarios, e.g., in case of APs that are fixed in their relative position within the communication environment. For ED units having a busy detector, such a learning phase may be applied in cases where they have a fixed position (e.g., mounted to furniture).

In some embodiments, only presence of IR radiation may be considered for busy channel detection. E.g., where no other IR radiation is present and transmitters are configured in a way that they do not transmit in a sleeping phase, any IR radiation can be used for busy channel detection.

In some embodiments, stationary APs may use backbone lines (e.g., data cabling 161 to 163 in FIG. 1) to inform each other about their transmitter activity (channel use) which may allow every registering AP to make a cross correlation (e.g., time correlation or correlation based on unique coding applied by each AP, wherein the coding could be in the form of an identifier, a phase-shifted pilot, a different wavelength busy signal, etc.) with detected (IR) radiation (straylight) to identify an AP located in the neighborhood. In many cases, the amplitude of a detected IR radiation (straylight) will be indicative for the number of reflections and hence allow to estimate the distance of identified APs. In such a mode, no real data needs to be transmitted (modulated on the radiation) for detection of neighboring OWC nodes e.g. in order to calibrate a neighborhood situation (e.g., neighbor table), e.g., for neighbor mapping to identify neighbors with overlapping coverage.

In some embodiments, photo detecting means (e.g., photo detectors such as photo diodes or other photo detection elements or arrays) for busy channel detection may be provided at a remote (central) location within a space and not be integrated in an AP. In such case, the photo detecting means may be configured to only register an intensity (or any other property) of detected (IR) straylight relevant for busy channel and/or neighbor detection and inform APs of this straylight information, e.g., via a backbone connection. Based thereon, each AP can check if its own OWC transmission had been detected and then estimate its distance from the remote photo detecting means, e.g., by time-of-flight methods or checking of transmission bandwidth, for learning and/or device identification/mapping purposes.

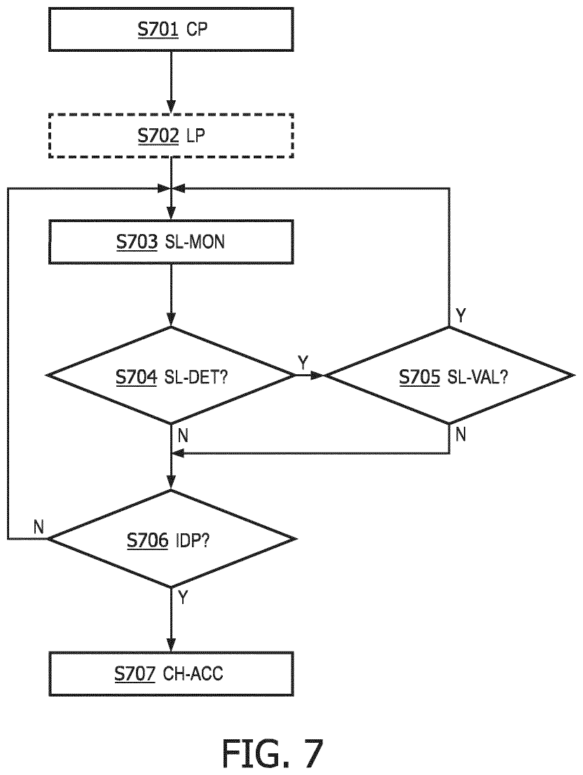

FIG. 7 shows a flow diagram of straylight-based busy channel detection procedure (which may be implemented in a controller e.g. of the detector 632 of FIG. 5) according to an embodiment.

An optional initial commissioning phase (CP) S701 may involve network formation, device identification/mapping, and logic configuration. Once an OWC network is formed, all its nodes need to be physically identified and mapped on a floor plan, so that desired interactions and scenarios can be set up. This can be done by a separate commissioning device (e.g., a smartphone or a tablet) isolated from the OWC network. The optional step S701 may be done at room level. It may however not be required for contention-based access. Mapping (to the extent needed for interference management) could be automated by the neighbor detection schemes described herein.

Then, an optional learning phase (LP) S702 may be initiated where environmental effects on busy channel detection (e.g., amount and level of reflections, neighboring OWC nodes, etc.) are learned, e.g., in an initial test phase or the like. Thereafter, when a transmission process is to be started, a straylight monitoring step (SL-MON) S703 for a predetermined time period (e.g., DIFS) is initiated (e.g., as described in connection with FIG. 3). In a subsequent straylight checking step (SL-DET) S704, it is checked whether straylight has been detected (e.g., by the additional photo detector 662 of FIG. 5). If so, it is additionally checked in a straylight validity checking step (SL-VAL) S705 whether the detected straylight stems from an interfering transmission source and thus indicates a busy channel. This checking process may involve e.g. at least one of detection of a predetermined busy channel indication (e.g. mark modulation, mark out-of-band sub-channel, mark channel, etc.) in the received straylight, reduction of a FOV to exclude non-interfering straylight, and comparison of the received straylight level with a predetermined threshold.

If a valid straylight that indicates a busy channel state has been determined in step S705, the procedure jumps back to step S703 and repeats straylight monitoring for the predetermined time period.

Otherwise, if no straylight has been detected in step S704 or no valid straylight that indicates a busy channel state has been determined in step S705, the procedure continues with an idle period checking step (IDP) where it is checked whether a predetermined idle period has expired (e.g., based on a backoff counter).

If the idle period has not yet expired, the procedure jumps back to step S703 and repeats straylight monitoring for the predetermined time period.

Otherwise, if the idle period has expired in step S706, the procedure continues with a channel access step (CH-ACC) S707, where the OWC channel is accessed, and the desired transmission is started.

After the transmission, the procedure may jump back to step S703 when a new transmission is to be initiated.

In a further embodiment directed to a neighbor mapping solution, the additional modulation signal may be coded allowing an identification of the transmitter that causes the straylight. Such an identification can be used to coordinate access to the OWC channel. Moreover, a learning phase may be applied to learn which transmitters may transmit in parallel without causing interference at the receiver and hence do not need to be checked for busy channel detection.

In a further embodiment, the modulation signal may be used to transmit a device identifier (e.g., an Internet Protocol (IP) or MAC address or a shorter local identifier) of the transmitting node at a very low data rate.

In a further embodiment, the receiver (e.g., the busy channel detector 632 of FIG. 5) may be configured to use or add pilot carriers of the communication channel in the received straylight to detect the presence of a transmitted signal. These pilot carriers may carry a known sequence (that has good autocorrelation properties, such as a maximum length sequence (MLS), thus enabling detection at very low signal levels. In a specific example, a different, known ‘phase’ of the MLS may be used on each pilot carrier, thereby allowing additional sum/difference detection of the MLS (e.g., {pilot1+/−pilot2}=MLS in a third phase) to enable faster detection of the complete sequence or a sufficient portion thereof.

In a further embodiment, each transmission source may be assigned a unique value of the relative phase shift on each pilot carrier of the previous embodiment as a means of ‘labelling’ each transmission source with a unique identifier. As previously mentioned, such an identification can also be used to coordinate access to the OWC channel.

In a further embodiment, noting that detection via autocorrelation will take a few symbol periods, each transmission may be pre-pended with a few symbols carrying only pilot signals to allow detection by neighboring nodes before the main signal is transmitted.

In a specific example, detection of the pilot signals of any of the above embodiments may be used as a basis of a listen-before-talk mechanism (such as Carrier Sense Multiple Access/Collision Avoidance (CSMA/CA)) where OWC nodes attempt to avoid collisions by beginning transmission only after the channel is sensed to be “idle” (e.g., as described in connection with the example of FIG. 3).

In some embodiments, APs may use periods where they do not transmit to search for straylight. They may then communicate with their neighbor APs or with a central controller when straylight has been detected and check whether any complaints from ED units have been received, which concern related interferences. In this way, a map of interfering APs can be built in the background, which can continuously be updated.

In an example, the APs may use idle or quiet times (e.g., at night) for neighborhood calibration. During these idle times, also other radiation sources that may cause straylight may be lowest and the APs may act together in a way that one activates its transmitter and others try to detect some straylight. In this way, the identity of a straylight source can be obtained. The APs may suppress transmissions of any ED units during these times to reduce other straylight sources.

In a further embodiment, the transmitter of an AP may use a very robust modulation scheme (for example, Binary Phase Shift Keying (BPSK) or pulse code modulation) for the transmission bandwidth in order to allow other APs to properly demodulate the mark signal. Note that due to relatively high RF reflectivity of many surfaces, not only a first reflection but multiple reflections may be generated, which may have different travel distance which leads to a reduction of the signal-to-noise (SNR) of the reception at high bandwidth. This behavior may also be used to estimate distance of neighbors by evaluating a maximum frequency transmitted (e.g., of the sub-bands of an Orthogonal Frequency Division Multiplexing (OFDM) transmission).

In a further embodiment, OWC neighborhood calibration may be activated in all OWC APs connected to a certain network or subnetwork. In this way, not only neighborhood but also room grouping may be easily calibrated. In an example, a coordinating AP recognizing no user data requests for a random time may issue a request to all APs on the backbone to enter a neighborhood calibration when they also have no user data requests pending. In this way, a firmware for neighborhood calibration can be installed on all APs and the first to have idle air-time will simply take over the coordinating role.

In an alternative embodiment, the coordination role may be distributed over the APs. An AP may initiate a neighbor AP detection activity, e.g., during night time or other idle times, by broadcasting a neighbor detection request message over the backbone. All APs may then stop data communication (if any) and start monitoring for detecting a reflected straylight of the requesting AP. After verifying quietness of neighbor data communication (e.g., by detecting no reflected straylight), the AP may transmit a test signal on which APs detecting the reflected straylight (i.e., the neighbor APs) send a neighbor detection response message over the backbone indicating the detection. After collecting the response messages, the initiating AP may terminate its neighbor detection activity by broadcasting a message indicating the end of the activity.

In this way, each AP may initiate such a request resulting that each AP will be informed about its neighboring AP relations both on how its transmission signal affects its neighboring APs as well as on how the transmission signals of its neighboring APs affect the AP itself. Before an AP initiates a request, it may verify that no other neighbor detection activity is ongoing. To avoid (any) collisions in requesting a neighbor detection activity, each AP may wait for a random time after detecting that that no other neighbor detection activity is ongoing.

A neighbor detection request message may contain an identifier of the requesting AP. Similarly, a neighbor detection response message may contain an identifier of the responding AP and optionally an indication of a detected level of the reflected straylight. It may also contain the identifier of the requesting AP. This allows for other APs in the network to be informed that a neighbor detection request had been issued and to report that they have not detected its straylight.

In addition, if multiple rooms share the same backbone, multiple neighbor detection requests may be issued in parallel and each requester may only process the related response messages.

In a further embodiment, the neighborhood calibration may only be executed during the first installation or on demand whenever the configuration or room layout changes. Moveable walls or curtains may trigger the calibration when moved.

In a further embodiment for OWC systems where APs are integrated with luminaires, the neighborhood calibration may also be basis for luminaire commissioning and grouping.

In an example, the busy signal may consist of light of a different wavelength than the communication signal that is emitted when the OWC node occupies the OWC channel. The wavelength may be chosen such that the OWC light can be easily filtered and no blinding for the OWC receiver is generated. E.g., a wavelength of 2000 nm may be used for channel busy marking when the OWC wavelength is in the range of 800-1000 nm. This allows for cheap filters for cutting off the marker light. Such an optional separate busy marker LED 652 is also shown in FIG. 6. It may be using the main transmitter optics 672 or a separate optic (not shown) for emission.

In a further embodiment, the transmitting OWC node may use a busy signal that is not just one wavelength but has a distinct spectral signature that facilitates discrimination from any other optical transmission sources in the surrounding space. The signature may be different for each transmitter, allowing identification of a transmitter that causes received straylight.

In a further embodiment, the busy signal (e.g., marker wavelength etc.) emission may be transmitted intermittently (e.g., pulsed) in a way that timers for initial idle periods (e.g., DIFS, EIFS, short interframe sequence (SIFS) etc.) do not expire in the transmission pauses. In this way, power consumption can be minimized while the channel will not be used by neighboring OWC nodes. This pulsing may also be used for pulse code modulation of an identifier of the OWC node.

In order to further optimize for power consumption, a learning phase may be used to learn how much intensity is required for the busy signals (e.g., marker emission etc.) to be recognized by the neighbor OWC nodes.

As a further option, coating of the ceiling of indoor system with highly reflective material for the OWC and/or marker wavelength may be applied to further reduce power consumption and reception quality for OWC nodes.

In a further embodiment, the busy marker LED 652 of FIG. 5 may emit a part of the modulated communication signal provided to the main transmitter LED 651. This part may be a subset of subcarriers or a single subcarrier in the lower frequency range of the communication signal's bandwidth.

To summarize, an OWC system has been described, that is configured to make use of observations of straylight reflections as generated by an OWC transmitter in order to support contention-based channel access including that of multiple basic service sets (BSS) or extended service sets (ESS) with overlapping coverage areas. It is proposed to have an additional optical signal or signal component generated in the OWC transmitter which allows for simple detection without having to do heavy digital demodulation processing. A learning phase may allow to adjust for environmental conditions like reflectivity or transmitter characteristics.

The above embodiments have mainly been described in connection with APs. However, they can also be applied for ED units where the signals reflected from the ceiling, at which APs are mounted, can be used as busy indication.

In all above embodiments, an AP can disable its busy signal if there are no neighbor APs (which can be derived e.g. from the commissioning phase) or if there are no ED units in an overlapping coverage (which can be derived e.g. from the learning phase). Moreover, an AP can control an ED unit to disable its busy signal if the AP knows there are no other ED units in the AP's coverage area (or in the case of distributed optical frontends (OFEs), in the coverage area of the OFE serving the ED unit. Disabling busy signals when not useful will help reduce power consumption.

Furthermore, in all above embodiments, the busy detector can be provided as a separate (replaceable) module, so that OWC nodes without straylight-based busy detection may easy be upgraded, e.g., as an aftermarket addition.

While the invention has been illustrated and described in detail in the drawings and foregoing description, such illustration and description are to be considered illustrative or exemplary and not restrictive. The invention is not limited to the disclosed embodiments. The proposed current density adaptation concept can be applied to other types of optical wireless networks and with other types of access devices, modems and transceivers. In particular, the invention is not limited to LiFi-related environments, such as the IEEE 802.11bb ITU-T G.9961, ITU-T G.9960, and ITU-T G.9991 network environment. It can be used in visible light communication (VLC) systems, IR data transmission systems, G.vlc systems, OFDM-based systems, connected lighting systems, OWC systems, and smart lighting systems.

Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. The foregoing description details certain embodiments of the invention. It will be appreciated, however, that no matter how detailed the foregoing appears in the text, the invention may be practiced in many ways, and is therefore not limited to the embodiments disclosed. It should be noted that the use of particular terminology when describing certain features or aspects of the invention should not be taken to imply that the terminology is being re-defined herein to be restricted to include any specific characteristics of the features or aspects of the invention with which that terminology is associated.

The described procedures like those indicated in FIG. 7 can be implemented as program code means of a computer program and/or as dedicated hardware of the receiver devices or transceiver devices, respectively. The computer program may be stored and/or distributed on a suitable medium, such as an optical storage medium or a solid-state medium, supplied together with or as part of other hardware, but may also be distributed in other forms, such as via the Internet or other wired or wireless telecommunication systems.

1. An apparatus for detecting a busy channel in an optical wireless communication, the apparatus comprising:
a detector for detecting a straylight signal originating from an environment of a target area; and
a discriminator for monitoring the detected straylight signal to discriminate a dedicated signal component that indicates channel occupancy by a neighbor transmission directed towards the target area.

2. The apparatus of claim 1, wherein the dedicated signal component comprises at least one of an additional out-of-band modulation, a code or address information allowing transmitter identification, a pilot carrier, a transmitter-specific spectral signature, a subset of subcarriers or a single subcarrier of the neighbor transmission.

3. The apparatus of claim 1, wherein the dedicated signal component is an intermittent signal component.

4. The apparatus of claim 1, wherein the detector is a separate detector with at least one of higher amplification or sensitivity, increased detection surface, and smaller signal bandwidth, as compared to a main detector used for the optical wireless communication.

5. The apparatus of claim 1, wherein the detector is arranged to surround the main detector at least partially.

6. The apparatus of claim 1, further comprising straylight receiving optics allocated to the detector and configured to provide a wider field of view than a field of view of main receiving optics allocated to the main detector used for optical wireless communication.

7. The apparatus of claim 6, wherein the straylight receiving optics are controllable to provide a variable field of view.

8. An optical wireless communication device comprising an apparatus as claimed in claim 1 and a transceiver for optical wireless communication.

9. The device of claim 8, wherein the device is configured to make use of a discriminated dedicated signal component to support coordinated channel access of multiple basic service sets with overlapping coverage areas.

10. The device of claim 8, wherein the device further comprises a busy signal generator configured to generate the dedicated signal component and to add the dedicated signal component to a drive signal for a main transmitter or a separate transmitter of the transceiver.

11. The device of claim 10, wherein the busy signal generator is coupled to a transmission optics of the device that provides a wider field of view than the transmission optics of the device used for the main transmitter.

12. The device of claim 8, wherein the device is configured to exchange with at least one other optical wireless communication device via a backbone network information about a channel usage by the transceiver for cross correlation with detected straylight signals to identify an optical wireless communication device located in the neighborhood or related interferences.

13. (canceled)

14. A method of detecting a busy channel in an optical wireless communication, the method comprising:
generating a dedicated signal component to indicate an occupied channel;
transmitting the dedicated signal component together with an optical communication signal towards a target area;
detecting a straylight signal originating from an environment of the target area; and
monitoring the detected straylight signal to discriminate the dedicated signal component as an indicator for channel occupancy by a neighbor transmission.

15. (canceled)
